(19) United States
(12) Patent Application Publication
(10) Pub. No.: US 2023/0049915 A1
(43) Pub. Date: Feb. 16, 2023

(54) DEVICE FOR THE SCATTERED LIGHT MEASUREMENT OF PARTICLES IN A GAS

(71) Applicant: DURAG GMBH, Hamburg (DE)

(72) Inventors: Sven Cierullies, Hamburg (DE); Birte Everts, Hamburg (DE); Bernd MULLER, Hamburg (DE)

(73) Assignee: DURAG GBMH, Hamburg (DE)

(21) Appl. No.: 17/797,795

(22) PCT Filed: Feb. 5, 2020
(86) PCT No.: PCT/EP2020/052845

§ 371 Date: Aug. 5, 2022

(51) Int. Cl. G01N 15/06

(52) U.S. Cl. CPC G01N 15/06; G01N 2015/0693

(57) ABSTRACT

A device for scattered light measurement of particles in a gas, comprising a light source, a beam splitter which splits a light beam emitted by the light source into a measuring beam and a reference beam, a light receiving device arranged at a distance from the beam splitter, which comprises at least one lens arranged in the reference beam with an optical axis aligned at an acute angle to the measuring beam, a first light receiver on the side of the lens facing away from the beam splitter, for receiving the scattered light imaged by the latter from a measurement volume in a gas-bearing region between the beam splitter and the lens, and a second light receiver on the side of the lens facing away from the beam splitter for receiving the reference beam imaged by the latter.

### BACKGROUND OF THE INVENTION

The invention concerns a device for scattered light measurement of particles in a gas. The device is designed to detect scattered light from a specified measurement volume through which a measuring beam passing along a first beam path passes, wherein a reference measurement, for example for a contamination correction or a correction of changes in the intensity of the light source, is realized using a reference beam passing along a second beam path which passes through the same optical interfaces in the same manner as the measuring beam.

Scattered light measurement is a well-known and proven method for determining the dust content in gaseous media. It is used, for example, to measure emissions of furnaces.

In emission measurement, a light beam is emitted from a light source into a measurement volume and is scattered by the dust particles. The scattered light is focused by receiving optics and detected by a light receiver and represents a measure of the particle concentration in the measurement volume.

The measured power is very small in relation to the irradiated power.

At the same time, despite protective measures such as purge air, there can be contamination of the optical interfaces. Such contamination must be detected during operation of the device in order to counteract any influence on the measurement results. In state-of-the-art devices, this is done by pivotable scattering normals or mechanical switching of light paths. For a representative measurement of the contamination, the light of the reference measurement should pass through the same optical interfaces in the same or at least similar direction as the measuring light at the same or closely neighboring points, if possible.

Furthermore, in terms of power, the light of the reference measurement should correspond to a real measurement signal, i.e. typically be attenuated by 5 to 6 orders of magnitude with respect to the emitted light intensity.

CH 571750 A5 describes a method for continuous contamination measurement of a surface in a smoke detector. In this case, however, it is assumed on the one hand that the contamination of the surface affects the transmission in the same way as the reflection, which is not necessarily true for dusts of different brightness. On the other hand, only the contamination on the transmitting side and not on the receiving side is measured in this case.

EP 1039426 A2 describes a measurement of contamination using the fraction of light backscattered from an interface. Again, however, depending on the color of the contamination, the relationship between transmission and reflection cannot be ascertained.

EP 0615218 A1 describes a method for measuring moisture precipitation. In this case, however, only the condensation on the receiving optics is measured by a separate source.

### BRIEF SUMMARY OF THE INVENTION

Taking this as a starting point, the object of the invention is to realize a scattered light measurement with reference measurement, in which the light on the reference path irradiates through the same optical elements as the light of the measurement path in the same or similar direction, the light on the reference path originates from the same light source as the light of the measurement path, but is attenuated in terms of its power, and no mechanical movable elements susceptible to interference and wear are required.

The object is solved by a device for scattered light measurement.

The device for scattered light measurement of particles in a gas according to the invention comprises a light source, a beam splitter which splits a light beam emitted by the light source into a measuring beam and a reference beam, a light receiving device arranged at a distance from the beam splitter, which comprises at least one lens arranged in the reference beam with an optical axis aligned at an acute angle to the measuring beam, a first light receiver on the side of the lens facing away from the beam splitter for receiving the scattered light imaged by the latter from a measurement volume in a gas-bearing region between the beam splitter and the lens, and a second light receiver on the side of the lens facing away from the beam splitter, for receiving the reference beam imaged by the latter.

Because the device according to the invention has a first light receiver for the scattered light and a second light receiver for the reference light, no mechanical switching of the measuring beam and the reference beam is required to measure them separately by means of the same light receiver. In this way, malfunctions and wear caused by mechanically moving elements are avoided.

Because the device has a first light receiver for the scattered light and a second light receiver for the reference beam, the measurement of scattered light and reference light can be performed sim-ultaneously.

This fundamentally improves the quality of the measurement. However, the meas-urements can also be temporally offset from each other, as in the prior art, where the measuring beam and reference beam are switched.

According to one embodiment of the invention, the beam splitter is a prism.

By splitting the light into a measuring beam and a reference beam by means of a beam splitter, the reference beam can be attenuated in comparison to the measuring beam.

According to a further embodiment, a light attenuating element is arranged in the reference beam. The light attenuating element can achieve an attenuation of the power of the reference beam by 5 to 6 orders of magnitude compared to the measuring beam, thereby better matching the power of the reference beam to the scattered light.

According to a further embodiment, the light attenuating element is a filter. The filter is preferably arranged on or in front of a closure disc to a gaseous region.

According to another embodiment, the light attenuating element is a coating on a closure disk for the gas-bearing region. According to a further embodiment, the coating is arranged on the inner side of the closure disc facing away from the gas-bearing region to prevent scratching of the coating when the disc is cleaned.

According to a further embodiment, the light receiving device has a light trap in the beam path of the measuring beam. The light trap catches the portion of the measured light that does not escape as scattered light from the gas-bearing region.

According to a further embodiment, the first light receiver is a first photosensitive element and/or the second light receiver is a second photosensitive element. For example, the first photosensitive element and/or the second photosensitive element is a photodiode and/or a phototransistor. According to another embodiment, the first light receiver is one end of a first photoconductor and the second light receiver is one end of a second photoconductor and the other end of the first photoconductor is coupled to a first photosensitive element and the other end of the second photoconductor is coupled to a second photosensitive element. Via the first photoconductors and/or the second photoconductors, the received light can be arranged to first and/or second photosensitive elements arranged at a distance from the gas-bearing region, for example, in a device housing in which the electronics of the device are arranged.

According to a further embodiment, the measured gas is fed to the device via a supply line.

According to another embodiment, the supply line is connected to an extraction system that is used to extract the measured gas from a chimney, another gas-bearing system, or the environment. In this embodiment, the device is designed as a measurement cell comprising the elements disclosed in claim 1 and, if applicable, the subclaims.

According to another embodiment, this measured gas is heated to vaporize condensed particles that would cause an inaccurate scattered light signal.

According to a further embodiment, purge air is introduced into this device via specially arranged openings, which prevents contamination of the optical interfaces. Furthermore, the purge air can prevent overheating of the optical and electrical components.

### BRIEF DESCRIPTION OF THE SEVERAL VIEWS OF THE DRAWINGS

The present invention will be explained in more detail in the following by way of the attached drawings. In the drawings show:

FIG. 1 an example of an embodiment in a roughly schematic longitudinal section.

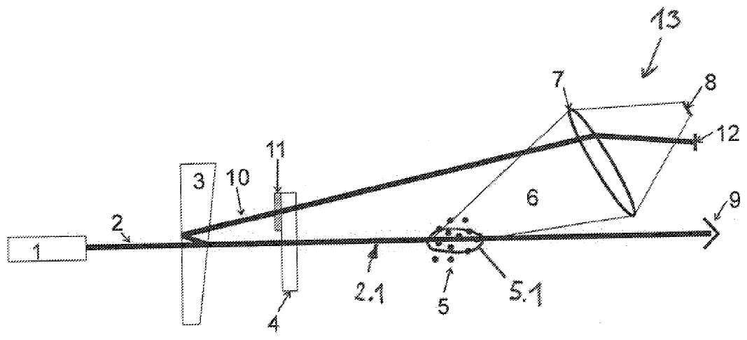

### DETAILED DESCRIPTION OF THE INVENTION

From a light source 1 a light beam 2 is emitted, most of which passes through a beam splitter 3 and a closure disc 4 into a gas-bearing region in which the gas to be measured is located or through which the gas to be measured flows. The light transmitted through the beam splitter 3 forms a measuring beam 2.1 that impinges on dust particles 5 in a measurement volume 5.1 in the gas-bearing region and generates scattered light 6 which is imaged through a lens 7 onto a first light receiver 8. The non-scattered portion of the measuring beam 2.1 is absorbed in a light trap 9.

In the beam splitter 3, a portion of the light beam 2 is split off as a reference beam 10 and, after passing through a light attenuating element 11, passes through the same closure disc 4 and the same lens 7 as the scattered light 6, but impinges on a separate second light receiver 12. The first light receiver 8 is a first photosensitive element. The second light receiver 12 is a second photosensitive element. Instead of one single lens 7, there may also be a plurality of lenses. Furthermore, instead of the lens 7, there may be an objective lens comprising one or more lenses. The components 7, 8, 9, 12 are parts of a light receiving device 13.

The light source 1 is, for example, a laser or an LED.

With this device, a scattered light signal proportional to the dust content in the measured gas and a reference signal of the same order of magnitude with respect to power can be measured simulta-neously. The necessary attenuation of the reference signal is provided by the beam splitter 3 with a low uncoupling and by the light attenuating element 11. The light attenuating element 11 is a coating on or in front of the closure disc 4.

It is particularly simple and advantageous to use a prism as beam splitter 3. As is known to the person skilled in the art, about 4% of the light is reflected at an air-glass transition at perpendicular incidence, so that the uncoupled portion of the light after two reflections accounts for about 0.16% of the portion of the transmitted light. Thus, to achieve six orders of magnitude of attenuation, the light attenuating element 11 need only have 0.1% transmission. Such coatings represent the state of the art and are widely available.

### REFERENCE SYMBOL LIST

1 Light source
2 Light beam
2.1 Measuring beam
3 Beam splitter
4 Closure disk
5 Dust particles
5.1 Measurement volume
6 Scattered light
7 Lens
8 Light receiver
9 Light trap
10 Reference beam
11 Light attenuating element
12 Second light receiver
13 Light receiving device

1. A device for scattered light measurement of particles in a gas comprising a light source (1), a beam splitter (3) which splits a light beam (2) emitted by the light source (1) into a measuring beam (2.1) and a reference beam (10), a light receiving device (13) arranged at a distance from the beam splitter (3), which light receiving device (13) comprises at least one lens (7) arranged in the reference beam (10) with an optical axis aligned at an acute angle to the measuring beam, a first light receiver (8) on the side of the lens (7) facing away from the beam splitter (3) for receiving the scattered light imaged by the latter from a measurement volume (5.1) in a gas-bearing region between the beam splitter (3) and the lens (7), and a second light receiver (12) on the side of the lens (7) facing away from the beam splitter (3) for receiving the reference beam (10) imaged by the latter.

2. The device according to claim 1, wherein the beam splitter (3) is a prism.

3. The device according to claim 1, wherein a light attenuating element (11) is arranged in the reference beam (10).

4. The device according to any of claim 1, wherein the light attenuating element (11) is a filter.

5. The device according to claim 3, wherein the light attenuating element (11) is a coating on a closure disc (4) for the gas-bearing region.

6. The device according to claim 5, wherein the coating is arranged on the inner side of the closure disc (4) facing away from the gas-bearing region.

7. The device according to any of claim 1, wherein the light receiving device (13) has a light trap (9) in the beam path of the measuring beam (2.1).

8. The device according to any of claim 1, wherein the first light receiver (8) is a first photosensitive element and/or wherein the second light receiver (12) is a second photosensitive element.

9. The device according to claim 1, wherein the second light receiver (12) is arranged at a distance from the first light receiver (8).

10. The device according to any of claim 1, comprising a measurement cell having elements (1) to (12), wherein the measured gas is directed to said measurement cell and is passed therein through the measurement volume (5.1).

11. The device according to claim 10, wherein the measured gas is heated to vaporize condensed particles.

12. The device according to claim 10, wherein purge air flows through specially arranged openings.
